(19) United States
(12) Patent Application Publication
(10) Pub. No.: US 2009/0017649 A1
(43) Pub. Date: Jan. 15, 2009

(54) METHOD AND APPARATUS FOR REDUCTION OF EXTERNAL ELASTOMERIC CONNECTOR COMPRESSION FORCE

(75) Inventors: Hongqi Wu, Chengdu (CN); Shanquan Bao, Alameda, CA (US); Taojin Le, Hangzhou (CN); Liming Gao, Alameda, CA (US)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, Alameda, CA (US)

(21) Appl. No.: 11/775,406

(22) Filed: Jul. 10, 2007

(51) Int. Cl. H01R 12/00

(52) U.S. Cl. 439/81

(57) ABSTRACT

A connector system employs a first connector moiety on an insertable miniaturized form factor card. A mobile information device (MID) has a printed circuit board having a second connector moiety and a frame mounted on the MID PCB for receiving the card. A slot is present in the frame for engagement of an elastomeric connector element in alignment with the second connector moiety. The card is positioned by the frame for alignment of the first connector moiety with the elastomeric connector element. The contact surface of the first connector moiety, as an example, multiple contact pads on the card, is extended, accomplished in the example by a matching plurality of individual metallic conductor extensions affixed to the plurality of contact pads using surface mount technology, and a cover attached to the frame is provided for urging the card into the frame and urging the extended contact surface to compress the elastomeric connector for positive contact.

### RELATED APPLICATIONS

This application is a related to U.S. application Ser. No. 11/308,559 filed on Apr. 6, 2006 entitled CONNECTOR FOR A HIGHLY INTEGRATED, INSTALLABLE MINIATURIZED FORM FACTOR CARD FOR WIRELESS COMMUNICATIONS FUNCTIONS having a common assignee with the present invention, the disclosure of which is incorporated herein as though fully set forth.

### BACKGROUND OF THE INVENTION—RELATED ART

U.S. patent application Ser. No. 11/308,221 filed on Mar. 13, 2006 entitled MINIATURIZED FORM FACTOR WIRELESS COMMUNICATIONS CARD FOR GENERIC MOBILE INFORMATION DEVICES, having a common assignee with the present invention and which is incorporated herein by reference in its entirety as though fully set forth, provides a system that allows communications capability to be inserted into a mobile information device without the usual lead times for design of wireless communications directly into the device itself. This system using a miniaturized form factor card provides the ability to integrate hardware, software, utilities and drivers which will allow true plug and play functionality for end users or mobile information device design houses. The desired functional capability is provided through an insertable card to eliminate the requirement for a separate CPU or applications processor in the mobile information device and additionally, provides a complete modem solution that will support multi-mode and multi-band.

To enhance the space savings and weight reduction to permit more compact portable devices and flexible designs and integrate chipset and passive components into a common module, the system provided in copending patent application Ser. No. 11/308,559 filed on Apr. 6, 2006 entitled CONNECTOR FOR A HIGHLY INTEGRATED, INSTALLABLE MINIATURIZED FORM FACTOR CARD FOR WIRELESS COMMUNICATIONS FUNCTIONS, having a common assignee with the present invention and which is incorporated herein by reference as though fully set forth, employs integral connector systems having standard interfaces and indexing for mating to PC boards within the mobile information device platforms and to properly index and mate the miniaturized form factor card. To further enhance the connector in such a common module it is desirable that the connector system incorporate integral alignment systems for accurate placement of the miniature form factor card within the connector system and the connector system on the printed circuit board in the generic mobile information devices.

Reliable connection of insertable cards, particularly by the end user, is a challenge for small devices with multiple pin connection. Integral elastomeric connectors provide a preferred solution, however, to provide adequate connection insertion forces may be higher than desired.

It is therefore desirable to provide a connector system which reduces the required insertion forces while maintaining sufficient force for reliable connector contact.

### SUMMARY OF THE INVENTION

The present invention provides a connector system having a first connector moiety on an insertable miniaturized form factor card. A mobile information device (MID) has a printed circuit board having a second connector moiety and a frame mounted on the MID PCB for receiving the card and having a slot for engagement of an elastomeric connector element in alignment with the second connector moiety, the card positioned by the frame for alignment of the first connector moiety with the elastomeric connector element. The contact surface of the first connector moiety is extended and a cover attached to the frame is provided for urging the card into the frame and urging the extending means to compress the elastomeric connector for positive contact.

In an exemplary embodiment, the first connector moiety incorporates multiple contact pads on the card and the extension of the contact surface is accomplished by a matching plurality of individual metallic conductor extensions affixed to the plurality of contact pads using surface mount technology. The hinged cover is movable from a first open position to receive the card to a second closed position contacting an upper surface of the card, urging the card into the frame and the conductor extensions into compression of the elastomeric connector.

### BRIEF DESCRIPTION OF THE DRAWINGS

These and other features and advantages of the present invention will be better understood by reference to the following detailed description when considered in connection with the accompanying drawings wherein:

FIG. 1A is an isometric view of the elements of a connector system for an insertable miniaturized form factor card for employing the present invention;

FIG. 1B is an isometric view of the system of FIG. 1a showing the printed circuit board (PCB) for the card and the elastomeric connector elements;

FIG. 2A is an isometric view of an exemplary PCB employing connector pads for an elastomeric connector as known in the prior art;

FIG. 2B is a side section view of the card of FIG. 2a showing a mating elastomeric connector element and a mating PCB;

FIG. 3A is an isometric view of a PCB for an insertable card employing a first embodiment of the present invention employing connector pads with connector extensions for an elastomeric connector;

FIG. 3B is an isometric view of the PCB of FIG. 3a for the first embodiment of the present invention with the connector pads having the connector extensions installed;

FIG. 3C is a side section view of the insertable card of FIG. 3a showing a matins elastomeric connector element and a mating PCB in a mobile device host;

FIG. 4 is an isometric view of the elements to be assembled using surface mount technology for the exemplary first embodiment with the assembly ascetabula;

FIG. 5A is a side view of the uncompressed elastomeric connector element;

FIG. 5B is a side section view showing the relative compression of the elastomeric connector by the extended pads on the PCB; and

FIG. 6 is a side sectional view of an alternative embodiment of the conector pad extensions.

### DETAILED DESCRIPTION OF THE INVENTION

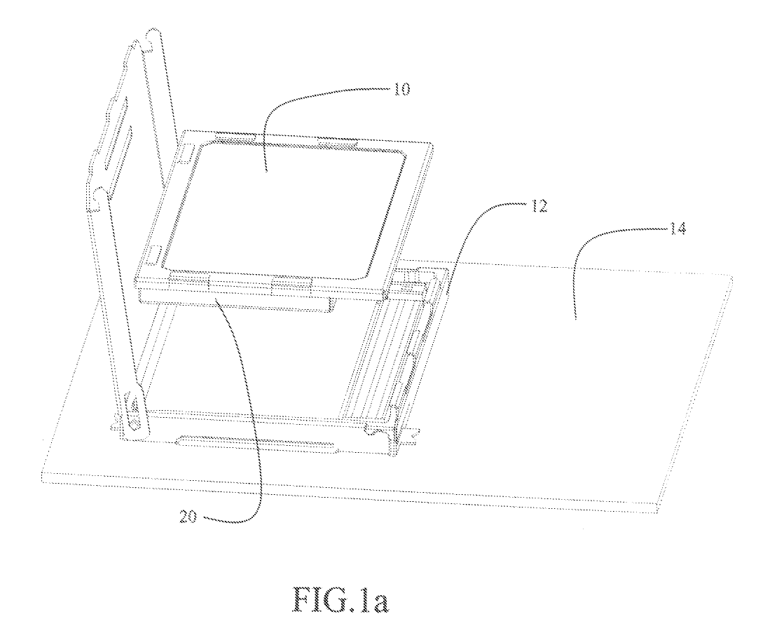

FIGS. 1A and 1B show a connector system for employing embodiments of the present invention having miniaturized form factor card 10 received within a frame 12 mounted to PC board 14 in a Mobile Information Device (MID) handset. Circuit connection to the MID PCB is provided by an elastomeric connector element 16, contained within connector receiving slot 18 in the frame to receive the mating elements of a first connector moiety on the card. An exemplary elastomeric connector is a STAX™ connector produced by Tyco Electronics. For the digital signals connector, a STAX™ model LD connector is employed in exemplary embodiments. The elastomeric connector element engages contact pads on the PCB in the MID for completing the circuit functionality.

The card is installed in the MID, for the embodiment of the connector system shown in FIGS. 1A and 1B, by insertion vertically within frame 12 which receives the external edges 20 of the card. A hinged cover 22 is provided on the frame to secure the entire card within the frame alter insertion, urging the connector moieties into firm engagement. PCB 24 with the card covers removed is shown in FIG. 1a with the elastomeric connector is shown exploded from the slot in the frame for greater clarity.

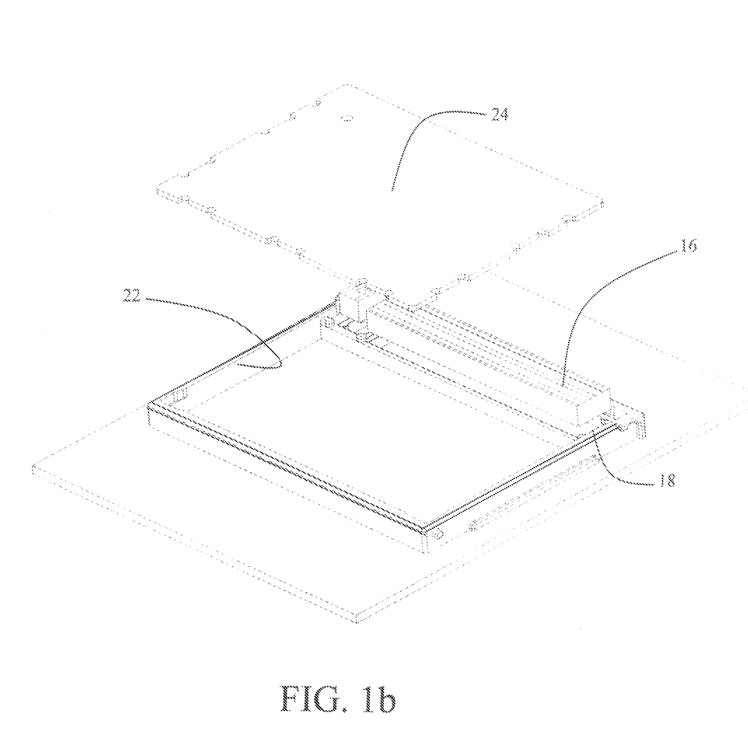

As shown in FIG. 2A, connector pads 26 are incorporated cm the PCB in the card. For prior art devices, the pads were substantially flush with the PCB surface extending only the thickness of the etched plating layer employed in normal processing of the PCB. The pads contact the elastomeric connector 16 as shown in FIG. 2B which provides connection to mating connector pads 28 on the MID PCB. For fixed devices, this form of connection is satisfactory. However, for applications in which the end user may insert and remove the miniaturized form factor card, integral contact is not reliably assured with connection forces that are acceptable. Excess connection forces may score or otherwise damage the contact pads or the elastomeric connector.

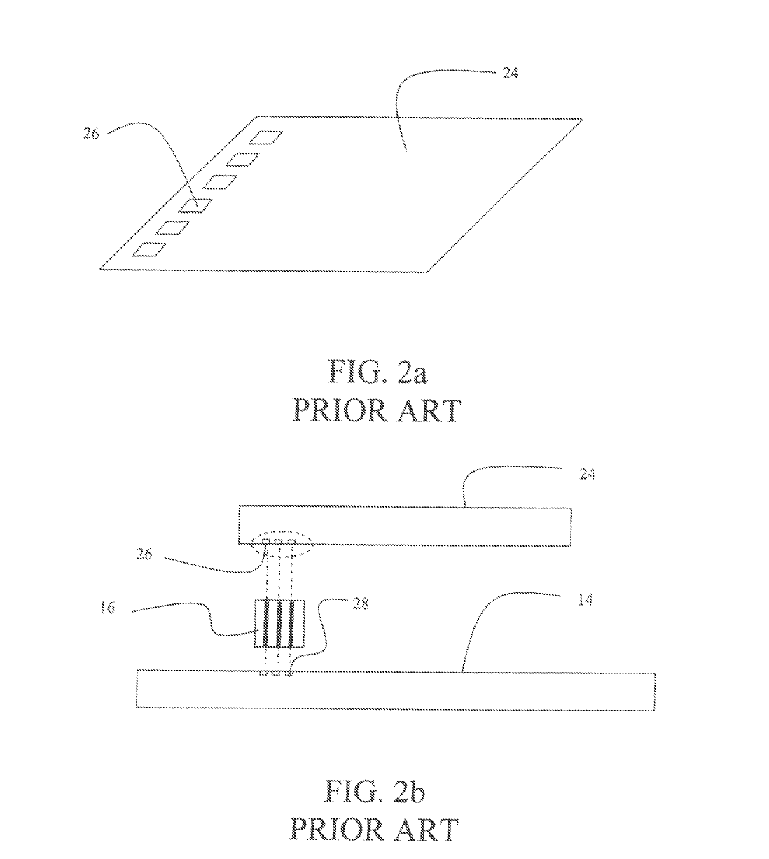

FIGS. 3A through 3C show a first embodiment of the present invention in which copper extension pads 30 are attached to pads 26 on the card PCB. This reduces the compression force by reducing contact area substantially eliminating the contact of card PCB surface on the elastomeric connector element while increasing compression distance on the elastomeric element.

Increasing contact height of the contact pads to make them stand above the surface of the card PCB, or alternatively increasing contact height of the contact pads on the MID PCB, reduces total Elastomeric connector contact area. With taller contact pads, the elastomeric connector element will only contact the pads on the card PCB rather than the card PCB surface area which does not need to contact elastomeric connector element.

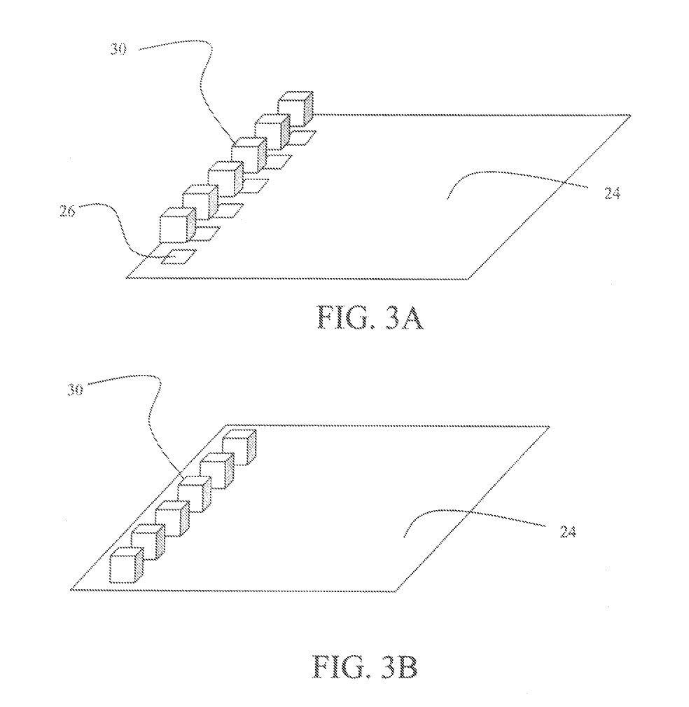

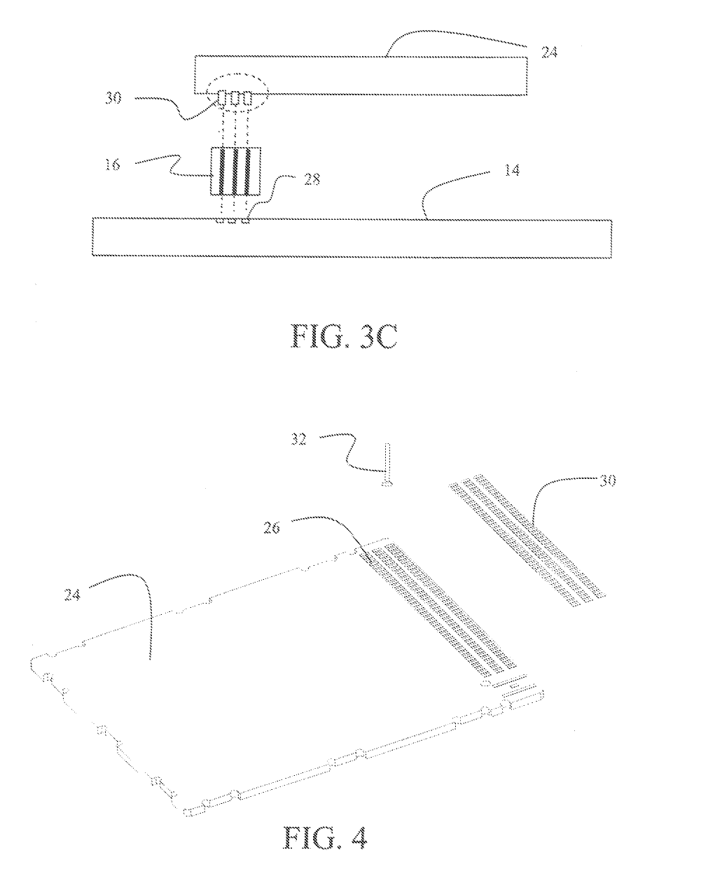

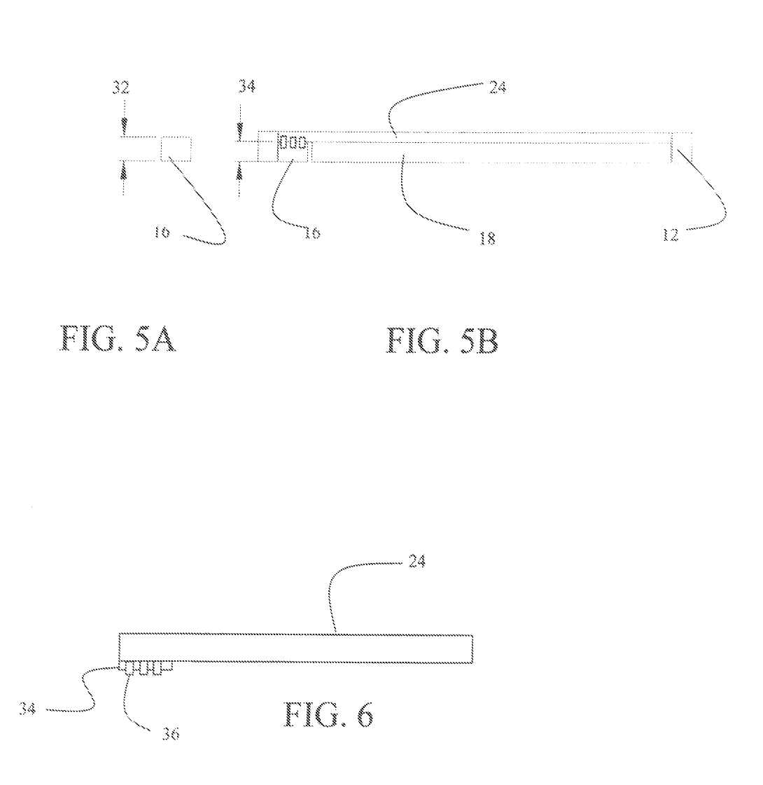

In the first exemplary embodiment, the pad extensions are individually formed from copper or other appropriate conductor material in a size to match pad area and provide the desired extension thickness. The extensions are then attached to the pads using surface mount technology (SMT). As shown in FIG. 4, an acetabula 32 in a numerical control (NC) pick-and-place machine individually grasps each extension placing it on a corresponding contact pad on the card PCB which has been dotted with adhesive for temporary adherence of the extension. After placement of the extensions, the card PCB is processed using standard SMT soldering techniques for permanent attachment of the extension. For initial embodiments, a thickness extension of about 0.2 to 0.3 mm is employed for addition to the card PCB nominal thickness of 0.75 mm with an initial elastomeric connector element height 32 of approximately 2.5 mm thereby providing a compression to a compressed height 34 of approximately 1.5 mm as demonstrated in FIGS. 5A and 5B. In alternative embodiments, the pad extension is achieved using a secondary PCB 36 which incorporates the individual pad extensions 38 as shown in FIG. 6 thereby simplifying the extension attachment to the PCB to a single step. Multiple layer deposition and etching is employed in yet other alternative embodiments for direct increase in pad height.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A connector system comprising:
a first connector moiety on an insertable miniaturized form factor card;
a mobile information device (MID) printed circuit board having a second connector moiety;
a frame mounted on the MID PCB for receiving the card and having a slot for engagement of an elastomeric connector element in alignment with the second connector moiety, the card positioned by the frame for alignment of the first connector moiety with the elastomeric connector element;
means for extending the contact surface of the first connector moiety; and,
means for urging the card into the frame and urging the extending means to compress the elastomeric connector for positive contact.

2. The connector system defined in claim 1 wherein the first connector moiety comprises a plurality of contact pads on the card and the extending means comprises a matching plurality of individual metallic conductor extensions affixed to the plurality of contact pads.

3. The connector system defined in claim 2 wherein the conductor extensions are affixed to the contact pads using surface mount technology.

4. The connector system defined in claim 1 wherein the urging means comprises a hinged cover attached to the frame and movable from a first open position to receive the card to a second closed position contacting an upper surface of the card, urging the card into the frame and the extending means for compression of the elastomeric connector.

5. The connector system defined in claim 2 wherein the elastomeric connector element has a relaxed thickness of about 2.5 mm and the conductor extensions have a length of about 0.3 mm.

6. A method for connection of a miniaturized form factor card on a mobile information device printed circuit board comprising the steps of:
providing a frame on the MID PCB to receive the card;
providing a first connector moiety on the card;
providing an elastomeric connector constrained by the frame and contacting a second connector moiety on the MID PCB;
extending the first connector moiety from a surface of the card;
urging the extended first connector moiety onto the elastomeric connector, compressing the connector at least by a vertical dimension of the extension.

7. The method of claim 6 in which providing the first connector moiety comprises the step of forming a plurality of contact pads on a PCB in the card and the step of extending the first connector moiety comprises the steps of:
forming a matching plurality of conductor extensions; and,
attaching the conductor extensions to the contact pads.

8. The method of claim 7 in which the step of attaching comprises the steps of:
positioning the extensions with a numerically controlled machine for adhesive attachment to the contact pads; and,
soldering the extensions to the contact pads.

9. The method of claim 8 wherein the step of urging the extended first connector moiety on the elastomeric connector comprises the steps of:
providing a hinged cover attached to the frame;
moving the cover from a first open position receiving the card to a second closed position urging the extensions into compressing contact with the elastomeric connector element.
